(19) United States
(12) Patent Application Publication
(10) Pub. No.: US 2003/0130938 A1
(43) Pub. Date: Jul. 10, 2003

(54) Coordination of independent billing and liquidity providers to facilitate electronic payments

(76) Inventor: James H. Wolfston JR., West Linn, OR (US)

Correspondence Address: MICHAEL O. SCHEINBERG, P.O. BOX 164140, AUSTIN, TX, 78716-4140, US

(21) Appl. No.: 10/041,946

(22) Filed: Jan. 7, 2002

(51) Int. Cl. G06F 17/60

(52) U.S. Cl. 705/39

(57) ABSTRACT

A system of financing fees to merchants entails uses a third party biller, such as a cellular telephone company, that has a large customer base and a robust billing system. When a payor desires to make a payment, he provides the merchant or broker representing the merchant with an account identifier, phone number, and a PIN number from the third party biller. The payment, minus service charges is transferred to the institution from a fund owned and managed independently of the third party biller, thereby providing rapid payment to the merchant. The biller is compensated by a billing charge and/or by use of the collected funds for a period of time before the funds are repaid to the fund. The system provides liquidity to the merchant and a convenient payment alternative to the payor. The cost to the merchant is potentially much less than the cost of processing credit card payments, with a portion of the cost potentially returned to the merchant in cases where the merchant is an investor in the fund.

### TECHNICAL FIELD OF THE INVENTION

The present invention relates to the field of financial transactions and, in particular, to establishing an alternative to the credit card network.

### BACKGROUND OF THE INVENTION

Credit cards are ubiquitous because they serve the needs of consumers and merchants. Credit cards are convenient for consumers, allowing them to make purchases without cash, whether in a store or over the telephone or Internet. Credit cards not only increase sales by facilitating purchases, they provide merchants with immediate cash and eliminate the risks associated with personal checks. For processing credit card transactions, merchants typically pay fees of between one percent and four percent of the amount charged. Rather than describing fees as a percentage of a charge, the finance industry often uses the term “basis point,” with each basis point being equal to one ten thousandth of the original charge, that is, one hundredth of one percent. Thus, a merchant typically pays a fee of between 100 and 400 basis points for a charge transaction.

Major credit cards, such as VISA, MasterCard, American Express, Diners Club, and Discover Card are useful to consumers because so many merchants accept them. To be successful merchants must accept major credit cards because consumers expect to be able to use them. A successful credit system requires a broad customer and merchant base to be successful. It would be difficult to establish a new major credit card to compete with existing cards; consumers will not accept a new card unless merchants honor it and merchants will not contract to honor a new card unless many consumers use it.

By way of example, many institutions of higher education, such as colleges and universities, allow students to pay for college expenses, including tuition, by credit card. Unlike the institutions, the credit card companies, which assume the risk of non-payment, have a robust billing and collection mechanism. While providing immediate cash to the university, the fees associated with the credit cards are a burden on the schools, most of which are non-profit institutions who would prefer to spend their limited resources on education rather than bank fees.

### SUMMARY OF THE INVENTION

An object of the invention is to provide an alternative system for processing payments that is convenient for payors, provides liquidity to merchants, and is potentially less expensive to merchants than the various credit card systems now available.

The present invention comprises a system in which one or more independent sources of liquidity provides funds to merchants involved in transactions, each source of liquidity being repaid by a third party biller that collects the funds from a payor in the transaction. In a preferred embodiment, the liquidity source and the biller in any transaction are not the same entity.

The foregoing has outlined rather broadly the features and technical advantages of the present invention in order that the detailed description of the invention that follows may be better understood. Additional features and advantages of the invention will be described hereinafter. It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims.

### BRIEF DESCRIPTION OF THE DRAWINGS

For a more thorough understanding of the present invention, and the advantages thereof, reference is now made to the following descriptions taken in conjunction with the accompanying drawings, in which:

FIG. 1 shows the parties and their interactions in a preferred embodiment of the invention.

FIG. 2 shows the steps used in a preferred embodiment.

FIG. 3 shows the hardware used to implement a preferred embodiment.

### DETAILED DESCRIPTION OF THE PREFERRED EMBODIMENTS

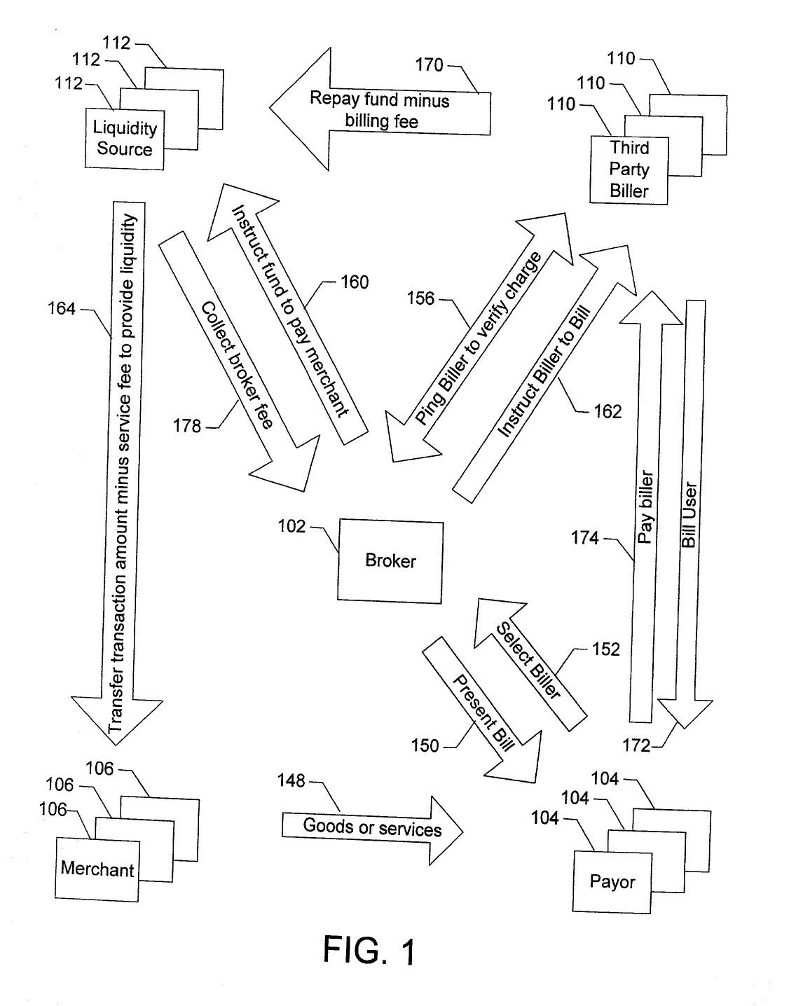

FIG. 1 shows a preferred embodiment of the present invention in which a broker 102 electronically processes payment of a transaction amount from a payor 104 to a merchant 106 by mediating between one or more independent billing systems operated by third party billers 110 and one or more independent sources of liquidity 112. For example, a source of payment to a group of higher education institutions (merchants) might be a mutual fund (liquidity source) that would provide rapid payment to any participating institution when a student payor charges a tuition payment to his or her account at a third party, for example, a cellular telephone utility.

The third party would subsequently collect the transaction amount from the payor and repay the liquidity source. The third party could be compensated, for example, by a billing fee, by the temporary use of the collected transaction amount before it is paid to the liquidity source, or by both a billing fee and use of the transaction amount. The third party billers preferably have extensive customer bases among the merchants' clients. The third parties are typically in the businesses of selling their own goods or services, and their billing systems are typically already in place to service their own customers. Unlike a credit card company, in which the same company provides the liquidity to the merchant and bills the payor, the third party biller in a preferred embodiment of the invention is typically a different entity from the liquidity source, that is, the entity that provides money to the merchant. For example, the third party biller may be a wireless communications provider such as AT&T, Verizon, or Sprint PCS; a department store, such as Nordstrom's, J.C. Penny's, or Sears; or an oil or gasoline company.

FIG. 1 uses arrows between the parties to show their interactions. In arrow or step 148, a merchant 106 provides, or promises to provide, goods or services to a payor 104. In step 150, a broker 102, such as CollegeNET, Inc. presents to a payor 104 on behalf of a merchant 106 a bill for the transaction amount for the goods or services. On the bill, broker 102 would offer several methods of payment, including the option to bill the transaction amount to one or more third parties 110 with whom the payor 104 might have an existing relationship. For example, third party biller may be a wireless communications provider such as AT&T, Verizon, or Sprint PCS. Assuming, for example, that ABC Wireless was a participating third party in the network, “Bill to my ABC Wireless account” could be listed as a choice on the payor's bill.

Assuming the payor had an account established with ABC Wireless and selects in step 152 “ABC Wireless” as the source of payment, the broker 102 would electronically “ping” the ABC Wireless server in step 156 with the payor name, phone number, PIN number, and transaction amount, and wait for receipt from the ABC Wireless server of acceptance of that charge. Assuming the ABC Wireless server returned an “OK” to broker 102, broker 102 would then mediate the electronic transfer of funds to the merchant 106 by electronically contacting in step 160 one of multiple liquidity sources 112 and instructing the selected third party biller 110, ABC wireless, to bill the payor 104, in step 162. An amount corresponding to the transaction amount, typically the transaction amount less a service fee, would then move in step 164 from the liquidity source 112 to the merchant 106, thereby providing liquidity substantially equivalent to that which would have been available to the merchant 106 had the transaction occurred via a credit card network.

The third party biller 110, in this example ABC Wireless, would be responsible for: (a) paying (step 170) the liquidity source 112 within a set period of days the full amount of the transaction less a billing fee; and (b) billing (step 172) and collecting from payor 104 (step 174) the full amount of the transaction. The broker 102 could collect from the liquidity source 106 (or from the third party 110) the broker's fee in step 178. In the preferred embodiment, the service fee would be greater than the sum of the broker's fee and the billing fee thus yielding a liquidity fee as a return to the fund.

Ideally, the fees would be established in such a way as to cost the merchants less than if the transaction were processed using a credit card. In any case, the proposed method for electronic payments would offer additional convenience and flexibility to the payor. Further, it would add an additional source of revenue to the third party by leveraging that third party's existing payor relationships and proven billing capability. The term “merchant” is used broadly to include any entity that the payor undertakes to pay and can include, for example, sellers of goods and services, institutions of higher education, lenders, and charities. The third party can require full payment from the payor upon billing or could allow the payor to pay over a period of time and charge the payor interest.

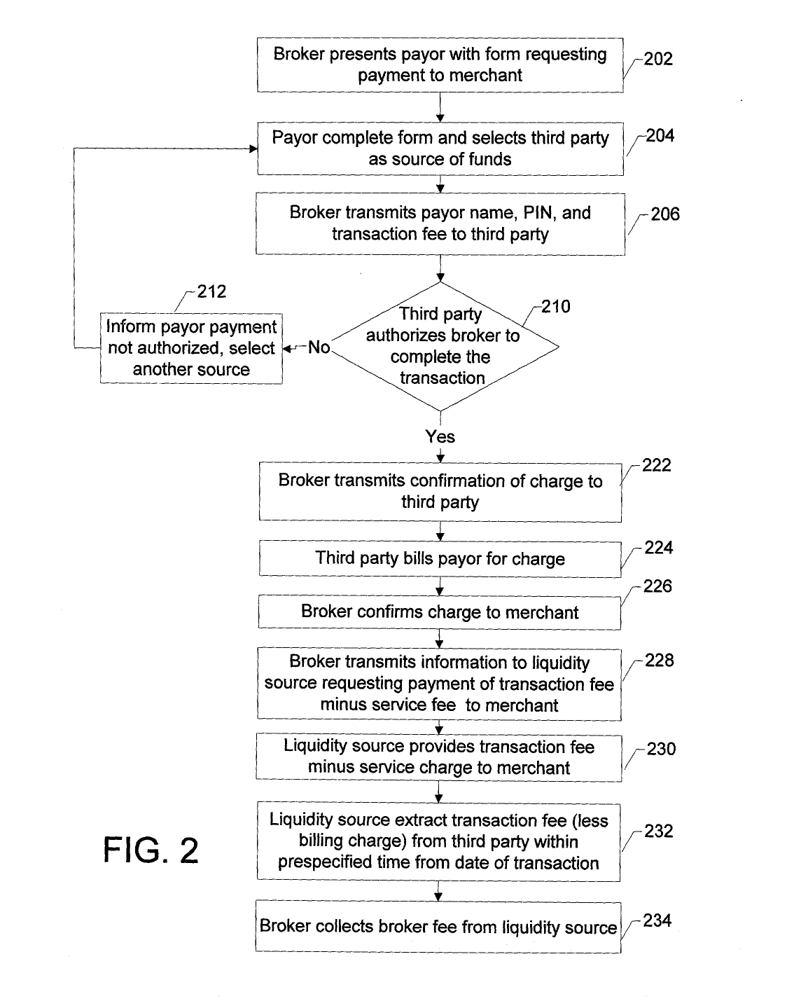

FIG. 2 is a flow chart showing the detailed steps of a preferred embodiment of the invention. In step 202, a broker presents the payor with a form requesting payment to a merchant. In step 204, the payor completes the form and selects a third party as a source of funds. Although the form is typically securely transmitted over a global computer network, such as the Internet, other methods of submitting the information include, for example, entering the information by telephone into an automated telephone system, conveying the information over a telephone to a human operator, or completing a paper form and mailing, faxing, or otherwise delivering the form to the institution.

In step 206, the broker securely transmits the payor name, account number, personal identification number, and transaction amount to the third party. In step 210, the third party determines whether to authorize the transaction. If the third party does not authorize the transaction, the broker presents in step 212 a message to the payor stating that the transaction was not authorized and requesting the payor to select a different source of payment in step 204. If the third party does authorize the payment in step 210, the broker transmits confirmation of the charge to the third party in step 222. In step 224, the third party bills the payor for the charge. The broker then confirms to the merchant in step 226 that the charge has been made and transmits information to a liquidity source requesting payment to the merchant in step 228. The liquidity source is typically a fund owned and managed separately from the third party biller and not affiliated with the third party. Similarly, the third party biller is typically not a traditional bank. The liquidity source may be a pooled fund in which the merchants invest, or it may be independent of the merchants. In step 230, the liquidity source provides the transaction amount minus a service fee to merchant. In step 232, after a pre-agreed number of days after the transaction, the liquidity source collects from the third party the transaction amount, less billing charges from the third party. In step 234, the broker collects a broker fee from the liquidity source.

At the conclusion of step 234, the merchant will have received his cash, and the payor will have paid the third party biller who has reimbursed the fund. The third party biller, the broker, and the liquidity fund will have been compensated. The liquidity fee and the billing fee can be extracted by the liquidity source or the third party, respectively, from funds they are transferring, or the fees can be paid to those parties in separate transactions.

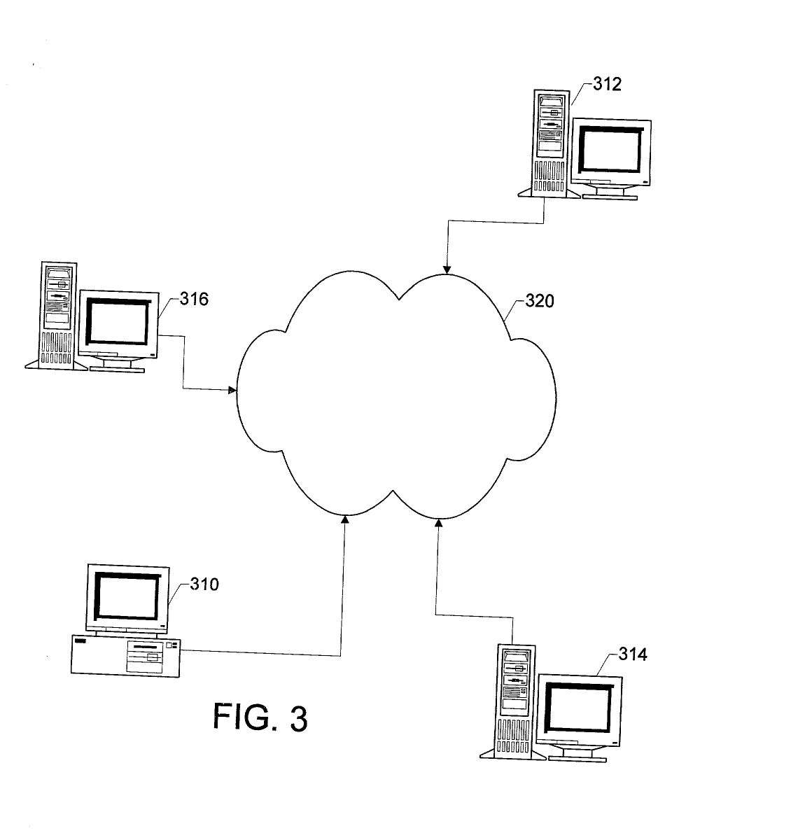

FIG. 3 shows the hardware used to implement a preferred embodiment. FIG. 3 shows a payor computer 310, a broker computer 312, a merchant computer 314, and a third party biller computer 316. The computers communicate through the Internet 320 or other network or data communications means. Any or all of the movement of information or funds can be performed electronically. It will be understood that transfers of funds will typically be performed through computers of financial institutions used by the various parties, rather than through the computers of the parties themselves.

In some embodiments, the broker can select the liquidity source from multiple liquidity sources available. The choice could be based, for example, on affiliations between the merchants and the liquidity sources or upon the fees charged by the liquidity sources. In other embodiments, a broker may not be necessary and the merchant can work directly with one or more third party billing sources and one or more liquidity sources.

In some embodiments, the merchants can be a group of institutions and the source of liquidity can be a pooled fund, referred to as a “utility payment fund.” The utility payment fund is used to provide the transaction amount to be transferred to any given institution after the biller authorizes the transaction. Before transferring the transaction amount to the institution, the utility payment fund can deduct from the full transaction amount a service fee comprising: (a) a billing fee paid to the third party; (b) a broker fee paid to the electronic broker mediating the transfer of information among the third party, the institution, and the utility payment fund; and (c) a liquidity fee retained by the fund. Because the utility payment fund could itself be funded by the institutions, the liquidity fee paid to the utility payment fund remains within the community of institutions, unlike credit card fees, which are paid to outside banks and lost to the institutions.

The invention is highly applicable for use in paying tuition or other fees to colleges or universities. Many colleges and universities currently pool their endowments and other funds into common investment funds. Those pooled funds can be managed more efficiently than separate funds for each institution. Moreover, the large pooled funds may have investment options available to them that would not be available to individual institutions. For example, one such fund, The Common Fund for Nonprofit Organizations, of Wilton, Conn., is a tax-exempt membership corporation operated by and for its member colleges, universities, and independent schools. Such a fund may include several investment options, including long term and short term investments. A utility payment fund for use with an embodiment of the present invention can comprise a short term investment fund owned and operated by participating institutions, similar to other pooled funds.

In one embodiment, the participating universities partner with one or more third party billers having wide customer bases among students and having robust billing and collection systems. The third party biller is typically an entity other than the entity that provides the funds. The third party biller typically offers it own products or services—for example, cellular phone services—that are different from the product or service—for example, academic services—offered by the institutions. Students could then charge their tuition or other fees to their cellular telephone accounts.

The tuition is credited to the university account from the utility payment fund, which would also pay a billing fee to the cellular telephone service provider. The cellular telephone service provider would also have use of the transaction amount collected from the student for a period of time before the funds were paid to the utility payment fund. The arrangement allows any participating institution to be paid rapidly after a payor selects a third party biller and that third party biller authorizes a payment to the institution.

The service fee could be any amount agreed upon by the parties, but is preferably below 200 basis points. The service fee is preferably less than that charged by credit card companies, although this embodiment would be advantageous to the institutions even if the fee were greater than that charged by credit card companies because a portion of the fee could be returned to the institutions through a jointly owned utility payment fund.

The billing fee could be any value agreed upon by the parties, but is preferably about 25 basis points. The broker fee could be any value agreed upon by the parties, but is preferably preferably about 50 basis points. The charge for the transaction amount can be included on the student's next telephone bill or a separate billing can be sent. The student is given a specified amount of time to pay the bill, for example, fifteen days, or the charge can be paid off over time, with interest.

A telephone company is a preferred billing partner in a system of the present invention because most students will already have an account with a telephone company. Cellular telephone companies in particular are useful because college students who live in dormitories or shared housing may not have a conventional telephone account, but are likely to have a cellular phone account. Telephone companies have robust billing systems and are experienced in collections. One reason that telephone companies are successful in collecting accounts is because they can terminate service if the account is not paid. Virtually any entity having a billing system can function as a third party biller in the system, and the invention provides a method by which any entity having a billing system can use its system to generate additional income.

At the completion of all the steps of a preferred embodiment, the institution has received the transaction amount from the utility payment fund, minus the service fee, preferably about 130 basis points. Of the 130 basis points, the utility payment fund has paid 25 basis points to the telephone company as a billing fee and 50 basis points to the broker as a broker or management fee. The utility payment fund retains the remaining 55 basis points as a liquidity fee. If the utility payment fund is jointly owned by the participating institutions, the 55 basis points is retained within the university community, with only the telephone company billing fee of 25 basis points and the broker fee of 50 basis points being lost to the university community. This is significantly less than the typical cost of one hundred to four hundred basis points that is paid to credit card companies, with all of those fees being lost to the university community.

Although the invention is illustrated above using a student, an institution of higher education, and a telephone company, the invention is not limited to any particular payor, payee, or third party biller. For example, the invention could be readily used, for example, by charities to facilitate donations or by other for profit or non-profit organizations. In some embodiments, the payor can contact the biller directly, rather than the broker, and the biller can process the charge, causing the pooled fund to credit the institution with the payment, minus service fees, and optionally crediting the biller with a billing fee. In other embodiments, a broker can facilitate transactions involving a multiplicity of billing agents (for example, the payee can be offered the option of paying via a cellular phone account, an electricity account, or a landlord account). Further, an embodiment may entail usage of more than one fund providing multiple sources of liquidity. There is also no limit to the type of fund that can be used as a liquidity source.

Although the present invention and its advantages have been described in detail, it should be understood that various changes, substitutions and alterations can be made herein without departing from the spirit and scope of the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

We claim as follows:

1. A method of financing transactions between payors and merchants, the payors charging utility or other billing accounts serviced by third parties in order to complete the transactions with the merchants, proceeds of the transactions being initially provided to the merchants by one or more participating funds owned and managed separately from the third parties and unaffiliated with those third parties, and the transaction proceeds being later restored to the funds by the third parties, the method comprising:
charging by a payor to a third party billing account a transaction amount charged by a merchant;
transferring from one of the participating funds to the merchant the transaction amount minus a service fee;
collecting by the third party the transaction amount from the payor; and
transferring funds corresponding to the transaction amount from the third party to the fund,
compensating the third party and the fund from the transaction amount, whereby the merchant has use of the major portion of the transaction amount shortly after charging by the payor, the third party receives compensation for its service, and the fund receives compensation that provides a return on investment to the fund to the benefit of its investors.

2. The method of claim 1 in which a broker fee is withheld by the fund from the merchant to compensate a broker for coordinating the transaction between the payor, the third party, the merchant, and the fund and further comprising transferring the broker fee to the broker.

3. The method of claim 1 in which transferring funds corresponding to the transaction amount from the third party to the fund includes transferring an amount equal to the transaction proceeds minus a billing fee.

4. The method of claim 1 in which the time between collecting the transaction amount from the payor and transferring the funds corresponding to the transaction amount to the fund is at least three days, thereby allowing the third party use of the transaction amount for at least three days.

5. A computer readable media having thereon instructions for executing computer instructions in accordance with claim 1.

6. A method of facilitating payment between a payor and a merchant, comprising:
undertaking by a payor of an obligation to pay a merchant a transaction amount;
providing funds corresponding to the transaction amount to the merchant from a liquidity source;
billing the payor by a third party biller, the third party biller being an entity other than the liquidity source;
collecting the transaction amount from the payor by the third party biller; and
providing by the third party biller funds corresponding to the transaction amount to the liquidity source, thereby providing liquidity to the merchant from the liquidity source and the liquidity source being repaid by payor funds collected by the third party biller.

7. The method of claim 6 in which providing funds corresponding to the transaction amount to the merchant from a liquidity source includes providing funds equal to the transaction amount minus a service fee, a first portion of the service fee being used to compensate the liquidity source and a second portion of the service fee being used to compensate the biller.

8. The method of claim 6 further comprising coordinating by a broker the flow of information and funds between the payor, the merchant, the third party biller, and the liquidity source, the broker being compensated by a third portion of the service fee.

9. The method of claim 6 in which providing funds corresponding to the transaction amount to the merchant from a liquidity source includes providing funds from a mutual fund.

10. The method of claim 6 in which billing the payor by a third party biller includes billing the payor by a third party that offers goods or services and that maintains a billing system for collecting charges in connection with its own goods or services.

11. A system of providing liquidity to merchants and facilitating payments by payors, comprising:
a source of funds for paying the merchant when a transaction is undertaken; and
a third party biller different from the source of funds for billing the payor, collecting funds from the payor, and reimbursing the source of funds.

12. The system of claim 11 in which the source of funds is a fund in which the merchant has invested.

13. The system of claim 11 in which the source of funds is other than a traditional bank.

14. A method of financing transactions between merchants and payors, comprising:
accepting money to be pooled in a fund;
in response to a transaction between a merchant and a payor, a transaction amount being charged to the payor's account at a third party who is unrelated to the party accepting the money to be pooled in the fund, transferring the transaction amount less a service fee from the pooled fund to the merchant; and
receiving funds corresponding to the transaction amount collected from the payor by the unrelated third party.

15. The method of claim 14 in which accepting money to be pooled in a fund includes accepting money from multiple merchants and further comprising distributing a potion of the service fee to one or more of the multiple merchants.

16. The method of claim 14 in which accepting money from multiple merchants includes accepting money from institutions of higher education.

17. The method of claim 14 in which transferring the transaction amount less a service fee from the pooled fund to the merchant includes transferring the transaction amount less a service fee in which the transaction amount is charged to the payor's account at a third party who maintains a billing system that bills for goods or services that are provided by the third party and that are not the subject of the transaction.

18. A method of brokering transactions between payors and merchants, comprising:
presenting to a payor, in response to a transaction between the payor and a merchant, a request to select an account at a third party biller to which to charge a transaction amount;
requesting authorization of the charge from the selected third party biller;
triggering the selected third party biller to bill the payor; and
requesting a liquidity source that is not the same entity as the third party biller to transfer funds corresponding to the transaction amount to the merchant, the liquidity source being repaid by the third party biller.

19. The method of claim 18 further comprising collecting a broker fee from the liquidity source or from the third party biller.

20. The method of claim 18 in which requesting a liquidity source to transfer funds includes selecting one of multiple liquidity sources.

21. The method of claim 18 in which requesting a liquidity source to transfer funds corresponding to the transaction fee to the merchant includes requesting the liquidity source to transfer funds equal to the transaction amount minus a service fee, a portion of the service fee being retained by the liquidity fund.

22. A method of facilitating payment between a payor and a merchant, comprising:
participating as a merchant in a transaction in which a payor agrees to pay the merchant a transaction amount to be charged to a billing account at a third party; and
receiving funds corresponding to the transaction amount from a liquidity source, the liquidity source being an entity other than the third party;
wherein participating in the transaction includes triggering a third party biller, to bill the payor;
collect the transaction amount from the payor; and
transfer a sum corresponding to the transaction amount to the liquidity source, the liquidity source providing liquidity to the merchant and being repaid by payor funds collected by the third party biller.

23. The method of claim 22 in which receiving funds corresponding to the transaction amount from a liquidity source includes receiving funds equal to the transaction amount minus a service fee that is paid in part to the liquidity source and in part to the third party biller.

24. The method of claim 22 participating as a merchant in a transaction in which a payor agrees to pay the merchant a transaction amount to be charged to a third party billing account includes having the payor select of a third party billing account from multiple third party billing accounts.

25. The method of claim 22 in which receiving funds corresponding to the transaction amount from a liquidity source includes receiving funds from a mutual fund.

26. The method of claim 22 in which receiving funds corresponding to the transaction amount from a liquidity source includes receiving funds from a pooled fund in which the merchant has invested.

27. The method of claim 22 in which participating as a merchant in a transaction in which a payor agrees to pay the merchant a transaction amount to be charged to a billing account at a third party includes participating as a merchant in a transaction in which a payor agrees to pay the merchant a transaction amount to be charged to a billing account at a third party that offers goods or services and in which a subject matter of the transaction is not the goods or services offered by the third party.

28. The method of claim 22 in which participating as a merchant in a transaction in which a payor agrees to pay the merchant a transaction amount to be charged to a billing account at a third party includes participating as a merchant in a transaction in which a payor agrees to pay the merchant a transaction amount to be charged to a billing account at a utility company, a department store, or an oil or gasoline company.

29. The method of claim 22 in which participating as a merchant in a transaction in which a payor agrees to pay the merchant a transaction amount to be charged to a billing account at a third party includes participating as a merchant in a transaction in which a payor agrees to pay the merchant a transaction amount to be charged to a billing account at a cellular telephone provider.

30. A method of facilitating a transaction between a merchant and a payor, comprising:
verifying by a biller the validity of a charge of a transaction amount for a transaction between a merchant and a payor;
charging the transaction amount to the payor's account, thereby triggering payment of an amount corresponding to the transaction amount from a liquidity source to the merchant, the liquidity source being unaffiliated with the biller;
collecting the transaction amount from the payor; and
transferring an amount corresponding to the transaction amount to repay the liquidity source.

31. The method of claim 30 in which verifying the validity of a charge of a transaction amount for goods or services provided by a merchant includes verifying the validity of a charge by a biller that provides goods or services different from those that are the subject of the transaction.

32. The method of claim 30 in which charging the transaction amount to the payor's account, thereby triggering payment of an amount corresponding to the transaction amount from a liquidity source to the merchant, includes triggering payment of the transaction mount minus a service fee and further comprising receiving a portion of the service fee as a billing fee.

33. A method of facilitating a transaction between a payor and a merchant, comprising:
performing a transaction with a merchant;
indicating an account at a third party biller to which to charge a transaction amount, thereby triggering payment of an amount corresponding to the transaction amount to the merchant from a liquidity source that is not the same entity as the third party biller; and
paying the transaction amount to the third party biller so that the third party biller can repay the liquidity fund from the transaction amount.

34. The method of claim 33 in which the indicating an account at a third party biller to which to charge a transaction amount includes indicating an account at a third party biller that provides to the payor goods or services different from those that are the subject of the transaction.
